(19) United States
(12) Patent Application Publication
(10) Pub. No.: US 2018/0009350 A1
(43) Pub. Date: Jan. 11, 2018

(54) Disposable Child Seat Cover and Method of Using

(71) Applicant: Yariv Shmueli, Holon (IL)

(72) Inventor: Yariv Shmueli, Holon (IL)

(21) Appl. No.: 15/168,075

(22) Filed: May 29, 2016

(51) Int. Cl. B60N 2/60; B60N 2/28

(52) U.S. Cl. CPC B60N 2/6054; B60N 2/6081; B60N 2/2881

(57) ABSTRACT

A disposable child seat cover for covering a child seat generally having a horizontal seat cushion, a back rest projecting upwardly from the seat cushion, at least a pair of shoulder straps with complementary connectors, the shoulder straps coupled to the back rest, and at least crotch strap with a buckle to connect with the connectors, the crotch strap coupled to the horizontal seat cushion. The disposable child seat cover includes an one-piece covering member defining a periphery, the covering member having a recess formed thereon to receive the crotch strap and secure the covering member on the child seat. The crotch strap is capable of being engaged with the connectors upon being received in the recess.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

The present disclosure generally relates to child seat covers, and, more particularly, to disposable child seat covers for covering a child seat and a method for using such seat.

### BACKGROUND

Child seats includes various strap arrangements emerging from the respective anchor points of the child seat to effectively restraint a child seating on such child seat in a safe manner. Generally, five anchor points with strap arrangements are quite popular in the child seat industries. Child seat industries have been continuously putting effort in terms of child safety and comfort and it is recognized that child seat often include padding and/or a fabric for child comfort along with the strap arrangements.

More often than not, parents of the children have concern over the dirtiness of the child seat and that enable them to generally include covers over the padding to avoid the child seat being dirty. In order to accommodate the covers over the seat, the covers are required to correspond as per various anchor points and related strap arrangements to allow the straps to engage with the cover to cover the child seat.

However, it is recognized that children are not the cleanest of creatures, and parents greatly suffer due to that. The problem of parents is added when they are driving cars with child seat having such covers as it is risky to stop the car on the highways to change the cover and that to with the various anchor points and related strap arrangements. This presents a problem, because there not much the parents can do about the child seat as the child seats are required to be manufactured in a way it is in view of child safety, and the changing such covers is also quite a task and cumbersome.

Accordingly, there exists a need of child seat covers that may obviate such problems and provide comfort to parents and children without deviating child seat design.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A general object of the present disclosure is to describe a simple child seat covers that may obviate problems and provide comfort to parents and children without deviating child seat safety design. Specifically, an object of the present disclosure is to describe a disposable child seat cover that may be easy to use from parents' point of view and comfortable and hygienic from children's point of view.

In one aspect of the present disclosure, a disposable child seat cover for a child seat is provided to cover the car seat. The child car seat where the disposable child seat cover may be disposed may generally be five point belt harness seating arrangement that includes a horizontal seat cushion, a back rest projecting upwardly from the horizontal seat cushion, at least a pair of shoulder straps with complementary connectors, the shoulder straps coupled to the back rest, and at least one crotch strap coupled to the horizontal seat cushion, and includes a buckle to connect with the connectors.

The disposable child seat cover, in one embodiment may include an one-piece covering member defining a periphery. The one-piece covering member includes a first covering portion, a second covering portion and a recess. The first covering portion may rest on the horizontal seat cushion. The second covering portion may seamlessly extend from the first covering portion to rest on the back rest. The first covering portion may be broader in the periphery portion than the periphery portion of the second covering member. Further, a periphery portion between the first and second covering portions may be narrowest. The narrowest periphery portion cooperates with the shoulder straps. Moreover, the recess may centrally be formed on the first covering portion to receive the crotch strap and secure the one-piece covering member on the child seat. The crotch strap may be capable of being engaged with the connectors upon being received in the recess.

In one embodiment of the present disclosure, the one-piece covering member may be formed of absorbent pad. The absorbent pad may include an inner water permeable surface facing a child body, and an outer waterproof surface backing the inner water permeable surface. The outer waterproof surface may be facing the child seat if incorporated thereon.

In one embodiment of the present disclosure, the disposable child seat cover may further include an attaching mechanism coupled to the one-piece covering member to attach the disposable child seat cover to the child seat. In an example embodiment, the attaching mechanism may be a plurality of adhesive strips coupled to the one-piece covering member along the first and second covering portions disposed on the respective periphery portions along broader peripheral edges thereof.

In one embodiment of the present disclosure, the disposable child seat cover may further includes a lining stitched along the periphery of the one-piece covering member to seal the inner water permeable surface and the inner water permeable surface strengthening the absorbent pad.

In one embodiment of the present disclosure, the disposable child seat cover may on its outer waterproof backing surface include colorful characters.

In one embodiment of the present disclosure, a package may be provided including a plurality of disposable child seat covers folded there within.

In one embodiment, a method for using a disposable child seat cover on a child seat as summarized above is provided. The method includes providing a disposable child seat cover as summarized above. Further, the crotch strap may be received in the recess. The buckle of the crotch strap may be coupled to the connectors upon the crotch strap is received in the recess to secure the one-piece covering member on the child seat. The method further includes disposing the disposable child seat cover upon identifying the disposable child seat cover is carrying child waste. Disposing the disposable child seat cover may be performed by releasing the engaged buckle from the connectors and extracting the crotch strap from the recess.

These together with the other aspects of the present disclosure, along with the various features of novelty that characterize the present disclosure, are pointed out with particularity in the present disclosure. For a better understanding of the present disclosure, its operating advantages, and its uses, reference should be made to the accompanying drawings and descriptive matter in which there are illustrated exemplary embodiments of the present disclosure.

### BRIEF DESCRIPTION OF THE DRAWINGS

The foregoing summary, as well as the following Detailed Description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIGS. 1A and 1B illustrate top views of front and back sides of a disposable child seat cover, in accordance with one exemplary embodiment of the present disclosure;

FIG. 2 illustrates a disposable child seat cover in cooperation with a child seat, in accordance with one exemplary embodiment of the present disclosure; and

FIG. 3 illustrates a package carrying a disposable child seat cover, in accordance with one exemplary embodiment of the present disclosure.

Like reference numerals refer to like parts throughout the description of several views of the drawings.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

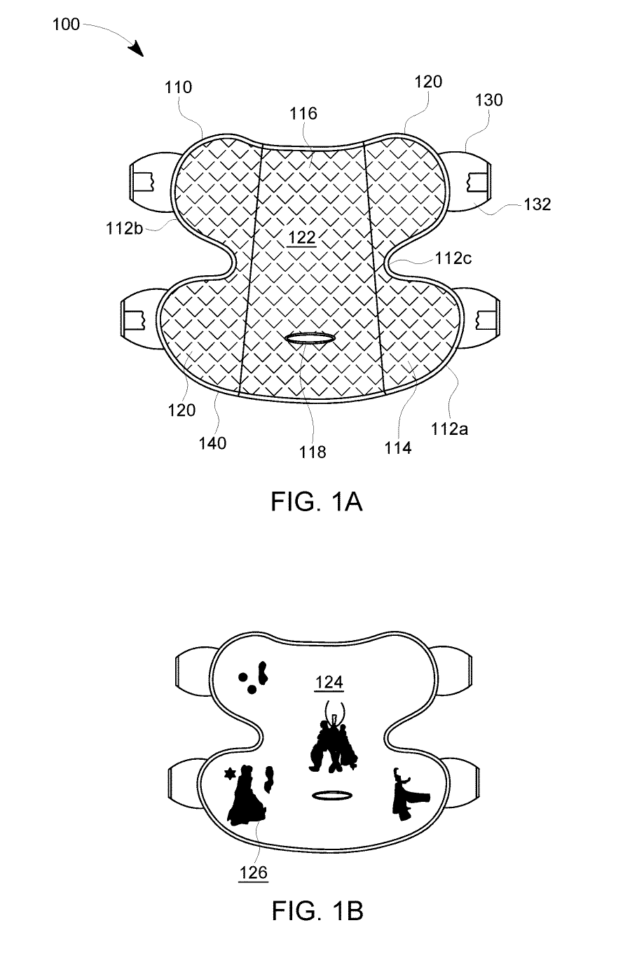

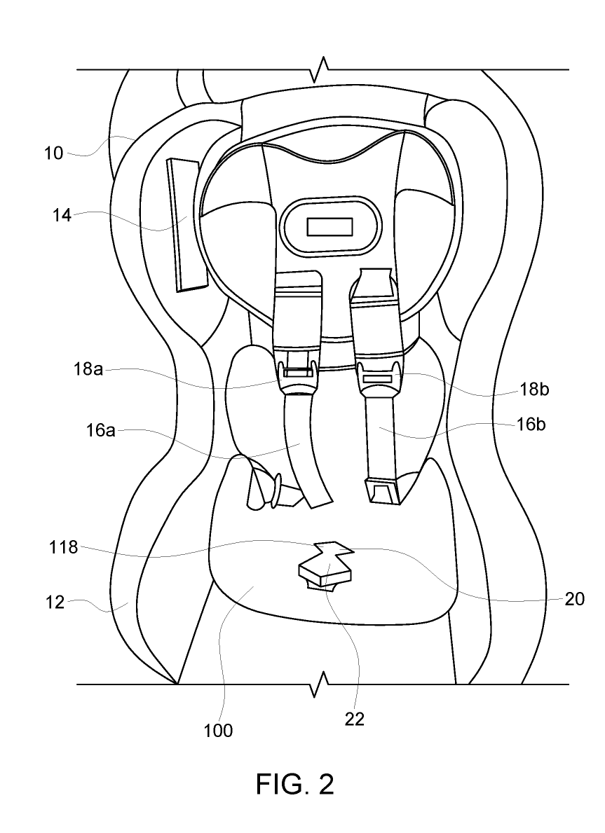

Referring to FIGS. 1A and 1B, example illustrations of front and back sides of a disposable child seat cover 100 are depicted, in accordance with an exemplary embodiment of the present disclosure. Further, FIG. 2 illustrates a disposable child seat cover 100 (hereinafter referred to as ‘disposable cover 100’) in use with a child seat 10 for covering the child seat 10, in accordance with an exemplary embodiment of the present disclosure. The disposable cover 100 and its use with the child seat 10 (also referred to as ‘seat 10’) will be described in the conjunction with FIGS. 1A, 1B and 2 herein. The disposable cover 100, as depicted in FIGS. 1A, 1B and 2, in one embodiment, may be used with the child seat 10 that may generally be five point belt harness seating arrangement having five respective anchor points to safely harness the child. In one example form, as shown in FIG. 2, the child seat 10 where the disposable cover 100 may be disposed may generally include a horizontal seat cushion 12, a back rest 14, at least a pair of shoulder straps 16a, 16b, and at least one crotch strap 20. The back rest 14 projects upwardly from the horizontal seat cushion 12. The back rest 14 projects upwardly from the horizontal seat cushion 12 to form a sitting position for a child to seat on the seat 10 with the upper body portion resting on the back rest 14, and lower body portion resting on the horizontal seat cushion 12. The shoulder straps 16a, 16b may include a respective complementary connector 18a, 18b coupled thereto to engage with each other. The shoulder straps 16a, 16b may be coupled to the back rest 14. Further, the crotch strap 20 may be coupled to the horizontal seat cushion 12. The crotch strap 20 may also include a buckle 22 to connect with the connectors 18a, 18b. The seat 10 may be a car child seat or any other types of child safety seat.

The disposable cover 100, in one embodiment may include an one-piece covering member 110 defining a periphery 112. In one example embodiment, the one-piece covering member 110 may be formed of absorbent pad 120 made of a fabric material. The absorbent pad 120 may include an inner water permeable surface 122 facing a child body, and an outer waterproof surface 124 backing the inner water permeable surface 122. The outer waterproof surface 124 may be facing the child seat 10 if incorporated on the seat. The one-piece covering member 110 includes a first covering portion 114, a second covering portion 116, and a recess 118.

The first covering portion 114 may rest on the horizontal seat cushion 12, when the disposable cover 100 is provided on the seat 10. Further, the second covering portion 116 may seamlessly extend from the first covering portion 114 to rest on the back rest 14, when the disposable cover 100 is provided on the seat 10. The first covering portion 114 may be broader in circumference along the periphery portion 112a than the circumference of the periphery portion 112b of the second covering member 116. Further, a periphery portion 112c between the first and second covering portions 114, 116 may be narrowest in circumference than the circumference of periphery portions 112a, 112b. When the disposable cover 100 is provided on the seat 10, the narrowest periphery portion 112c cooperates with the shoulder straps 16a, 16b in such a manner that the straps 16a, 16b pass from the narrowest periphery portion 112c and periphery portions 112a, 122b extend beyond the region of straps 16a, 16b, which enables disposable cover 100 to be securely disposed on the seat 10 and not come out easily while the child is seating on the seat 10.

Moreover, the recess 118 may be formed on the first covering portion 114 to receive the crotch strap 20 and secure the one-piece covering member 110 on the child seat 10. The crotch strap 20 may be capable of being engaged with the connectors 18a, 18b upon being received in the recess 118. In one embodiment, the recess 118 may be formed centrally on the first covering portion 114 so that when the crotch strap 20 is received in the recess 118, it also align centrally to pass from the child's crotch region and harness the child safely on the seat 10 having the disposable cover 100.

In one embodiment of the present disclosure, the disposable cover 100 may further includes an attaching mechanism 130 coupled to the one-piece covering member 110 to attach the disposable cover 100 to the child seat 10. In an example embodiment, the attaching mechanism 130 may be a plurality of adhesive strips 132 coupled to the one-piece covering member 110 along the first and second covering portions 114, 116. The adhesive strips 132 may be disposed on the respective periphery portions 112a, 112b along broader peripheral edges of the first and second covering portions 114, 116. However, without departing from the scope of the present disclosure, the attaching mechanism 130 may be any other arrangement that may be capable of attaching the disposable cover 100 to the child seat 10, such as Velcro, or the like.

In one embodiment of the present disclosure, the disposable cover 100 may further includes a lining 140 stitched along the periphery 112 of the one-piece covering member 110 to seal the inner water permeable surface 122 and the inner water permeable surface 122, thereby strengthening the absorbent pad 120. The lining may also be made of fabric material that may add strength to the absorbent pad 120 and increase durability of the disposable cover 100.

In one embodiment of the present disclosure, the disposable cover 100 may on its outer waterproof backing surface 124 includes colorful characters 126. The colorful character 126 may be any colorful illustrations that may be attractive to parents, and more importantly to children. In one example form, the colorful character 126 may be cartoon characters, such as Dora, Fireman, Sam, Princesses, Disney and the like, formed on the outer waterproof backing surface 124. However, without departing from the scope of the present disclosure, the colorful characters 126 may include any other designs or illustrations that are attractive to children or parents.

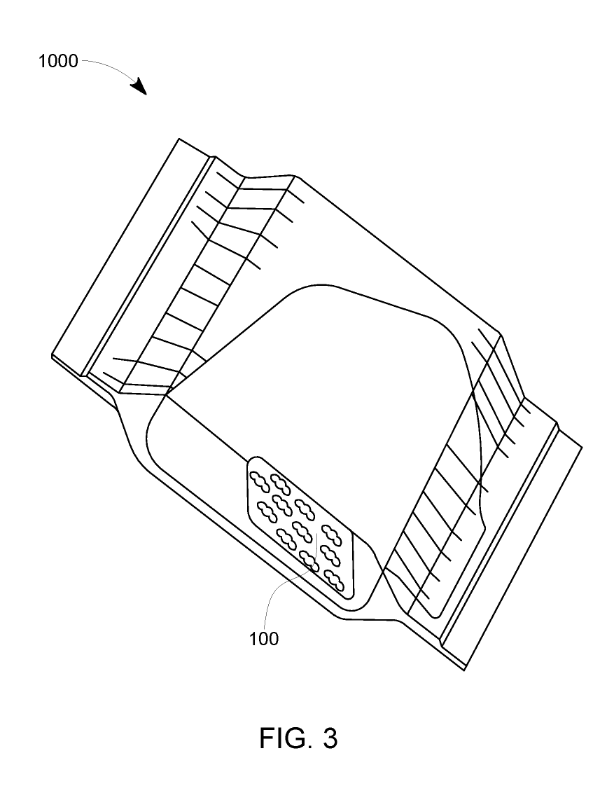

In one embodiment of the present disclosure, a package 1000 may be provided and shown in FIG. 3. The package 1000 may include a plurality of disposable covers 100 as discussed above, folded there within. Interest parents may buy the package 1000 that includes various such disposable covers 100 and may use to cover the child seat, where if the children pee or vomits, parents may not be required to save the disposable cover 100, but just dispose such disposable seat 100 off in a trash nearby. The package 1000 facilitates parents to carry a required volume of the disposable cover 100 and use thereto whenever required to use with ease and convenient, without the need to store and clean for later use, which are often inconvenient to parents.

In one embodiment, a method for using a disposable cover, such as the disposable cover 100, on a child seat, such as the child seat 10, as described above is provided. The method includes providing a disposable child seat cover, such as the disposable cover 100. Further, a crotch strap of seat 10, such as the crotch strap 20, is adapted to be received in a recess, such as the recess 118, of the disposable cover 100. Furthermore, the buckle, such as the buckle 22 of the crotch strap 20, may be coupled to the connectors, such as connectors 18a, 18b, upon the crotch strap 20 is being received in the recess 118 to secure one-piece covering member, such as the one-piece covering member 110, on the child seat 10. The method further includes disposing the disposable cover 100 upon identifying the disposable cover 100 is carrying child waste. Disposing of the disposable cover 100 may be performed by releasing the engaged buckle 22 from the connectors 18a, 18b and extracting the crotch strap 20 from the recess 118. Such easy using technique may be great relief to parents normally or when travelling.

The disposable cover 100 may be advantageous in various ways over conventional covers as it is simple, economical, easy, compact, disposable, and easy to use that provides comfort to parents and children without deviating child seat safety design of the seat, where it is incorporated. The disposable child seat covers are easy to use from parents' point of view and comfortable and hygienic from children's point of view. The disposable cover is built from one unit that may be integrated protection seat. The disposable cover is also advantageous to keep the child seat dry, free from odor and eliminates the requirement of flushing and cleaning thereof. The disposable cover is also suitable for all kind of child safety seat.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A disposable child seat cover for covering a child seat generally having a horizontal seat cushion, a back rest projecting upwardly from the horizontal seat cushion, at least a pair of shoulder straps with complementary connectors, the shoulder straps coupled to the back rest, and at least one crotch strap with a buckle to connect with the connectors, the crotch strap coupled to the horizontal seat cushion, the disposable child seat cover comprising:
an one-piece covering member defining a periphery, the one-piece covering member having:
a first covering portion that rests on the horizontal seat cushion,
a second covering portion extending from the first covering portion to rest on the back rest, the first covering portion being broader in the periphery portion than the periphery portion of the second covering member, and a periphery portion between the first and second covering portions being narrowest, wherein the narrowest periphery portion cooperates with the shoulder straps; and
a recess centrally formed on the first covering portion to receive the crotch strap and secure the one-piece covering member on the child seat, the crotch strap capable of being engaged with the connectors upon being received in the recess.

2. The disposable child seat cover according to claim 1, wherein the one-piece covering member is formed of absorbent pad comprising,
an inner water permeable surface facing a child body, and
an outer waterproof surface backing the inner water permeable surface, the outer waterproof surface facing the child seat.

3. The disposable child seat cover according to claim 1 further comprising an attaching mechanism coupled to the one-piece covering member to attach the disposable child seat cover to the child seat.

4. The disposable child seat cover according to claim 2, wherein the attaching mechanism is a plurality of adhesive strips coupled to the one-piece covering member along the first and second covering portions disposed on the respective periphery portions along broader peripheral edges thereof.

5. The disposable child seat cover according to claim 1 further comprising a lining disposed along the periphery of the one-piece covering member to seal the inner water permeable surface and the inner water permeable surface strengthening the absorbent pad.

6. The disposable child seat cover according to claim 1, wherein the outer waterproof backing surface having colorful characters.

7. A package comprising a plurality of disposable child seat covers of claim 1 folded there within.

8. A method for using a disposable child seat cover on a child seat generally having a horizontal seat cushion, a back rest projecting upwardly from the horizontal seat cushion, at least a pair of shoulder straps with complementary connectors, the shoulder straps coupled to the back rest, and at least crotch strap with a buckle to connect with the connectors, the crotch strap coupled to the horizontal seat cushion. the method, comprising:
providing a disposable child seat cover on the child seat, the disposable child seat cover comprising:
a one-piece covering member defining a periphery, the one-piece covering member having
a first covering portion that rests on the horizontal seat cushion,
a second covering portion extending from the first covering portion to rest on the back rest, the first covering portion being broader in the periphery portion than the periphery portion of the second covering member, and a periphery portion between the first and second covering portions being narrowest, wherein the narrowest periphery portion cooperates with the shoulder straps;
a recess centrally formed on the first covering portion to receive the crotch strap and secure the one-piece covering member on the child seat, the crotch strap capable of being engaged via the buckle with the connectors upon being received in the recess; and
receiving the crotch strap in the recess and engaging the buckle with the connectors, upon being received in the recess to secure the one-piece covering member on the child seat.

9. The method according to claim 8, further comprising disposing the disposable child seat cover upon identifying the disposable child seat cover is carrying child waste.

10. The method according to claim 9, wherein disposing the disposable child seat cover comprises releasing the engaged buckle from the connectors and extracting the crotch strap from the recess.
